(19) United States
(12) Patent Application Publication
(10) Pub. No.: US 2008/0226159 A1
(43) Pub. Date: Sep. 18, 2008

(54) Method and System For Calculating Depth Information of Object in Image

(75) Inventors: Byeongho CHOI, Yongin-si (KR); Hyok Song, Seongnam-si (KR); Jinwoo Bae, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Korea Electronics Technology Institute, Sungnam-si (KR)

(21) Appl. No.: 11/740,315

(22) Filed: Apr. 26, 2007

(30) Foreign Application Priority Data
Mar. 14, 2007 (KR) 10-2007-0025004

(51) Int. Cl. G06K 9/00

(52) U.S. Cl. 382/154

(57) ABSTRACT

A method and a system for calculating a depth information of objects in an image is disclosed. In accordance with the method and the system, an area occupied by two or more objects in the image is classified into an object area and an occlusion area using an outline information to obtain an accurate depth information of each of the objects.

### BACKGROUND OF THE INVENTION

1. Field of the Invention

The present invention relates to a method and a system for calculating a depth information of objects in an image, and in particular to a method and a system for calculating a depth information of objects in an image wherein an area occupied by two or more objects in the image is classified into an object area and an occlusion area using an outline information to obtain an accurate depth information of each of the objects.

2. Description of Prior Art

A stereo camera is special camera for obtaining two images simultaneously. The stereo camera includes two lenses being spaced apart by a predetermined distance for photographing an identical object. A 3-dimensional effect may be achieved when the two images are viewed through a stereoscopic viewer.

A human determines a distance by two eyes. The stereo camera has two lenses of an identical capability having a distance of about 6.5-7 cm since a distance between the two eyes is about 6-7 cm. A focusing, an exposure and a shutter of the two lenses are interlinked.

When a disparity of the image photographed by the stereo camera is obtained, a depth information (distance information) of an object in the image may be calculated.

Generally, a block-based disparity search method, which is a most basic disparity search method, comprises a basic method such as a full search method, a diamond search method and 3-step search method and a fast method. However, in accordance with the block-based disparity search method, a search is carried out using a sum of an absolute value of a difference of an entire comparison block without using an accurate optical flow. The method is disadvantageous in that a value different from an actual movement vector is determined to be the disparity. In case of a method using the optical flow, a left mage and a right image inputted via the camera are different due to an internal operation of the camera. Therefore, an accurate disparity cannot be calculated.

On the other hand, when a SIFT (Scale Invariant Feature Transform) method, which is one of most used feature-based search methods, is used, a number of feature points is not sufficient to find the disparity of an entirety of the image. Therefore, the accurate disparity cannot be detected.

### SUMMARY OF THE INVENTION

It is an object of the present invention to provide a method and a system for calculating a depth information of objects in an image wherein an area occupied by two or more objects in the image is classified into an object area and an occlusion area using an outline information to obtain an accurate depth information of each of the objects.

In order to achieve the above-described objects of the present invention, there is provided a method for detecting a depth information of each of a first object and a second object included in an image obtained from a stereo image input means, the method comprising steps of: (a) extracting an outline information of each of the first object and the second object; (b) detecting an occlusion area of the first object and the second object from the outline information; (c) detecting a disparity of each of the first object and the second object; and (d) detecting the depth information of each of the first object, the second object and the occlusion area from the disparity.

Preferably, the step (a) comprises extracting the outline information from a luminance graph of the image.

It is preferable that the step (b) comprises detecting an area between luminance edges of a luminance graph of the image as the occlusion area.

Preferably, the step (d) comprises correcting an error generated when detecting the depth information of the occlusion area.

It is preferable that correcting the error comprises assigning the depth information of the second object as that of the occlusion area.

There is also provided a depth information detection system comprising: an outline information extractor for extracting an outline information of each of a first object and a second object included in an image obtained from a stereo image input means; an occlusion area detector for detecting an occlusion area of the first object and the second object from the outline information; a controller for detecting a depth information of each of the first object, the second object and the occlusion area from a disparity of each of the first object and the second object detected from the image; and an error correction unit for detecting and correcting an error of the depth information of the occlusion area.

Preferably, the error correction unit assigns the depth information of the second object as that of the occlusion area.

### BRIEF DESCRIPTION OF THE DRAWINGS

FIG. 1 is a flow diagram illustrating a method for calculating a depth information of an object in accordance with the present invention.

FIG. 2 is a luminance graph used in an outline extraction process of an object in accordance with the present invention.

FIGS. 3a and 3b are diagrams illustrating a method for detecting an occlusion area of a method for detecting a depth information of an object in accordance with the present invention.

FIG. 4 is a block diagram illustrating a depth information detection system in accordance with the present invention.

### DETAILED DESCRIPTION OF THE PREFERRED EMBODIMENTS

Preferred embodiments of the present invention will now be described in detail with reference to the accompanied drawings. The preferred embodiments of the present invention may vary in their forms, and a scope of the present invention should not be limited to the embodiments described below. The preferred embodiments of the present invention are provided so as to give a complete description of the present invention to a skilled in the art.

FIG. 1 is a flow diagram illustrating a method for calculating a depth information of an object in accordance with the present invention.

Referring to FIG. 1, two or more objects, a first object and a second object for instance, are photographed using a stereo image input means to obtain an image (S100). When the two or more objects are photographed simultaneously, an occlusion area wherein the two or more objects overlap may be generated.

Thereafter, an outline information of each of the first object and the second object included in the image is extracted (S110).

The outline information may be obtained from a luminance graph of the image.

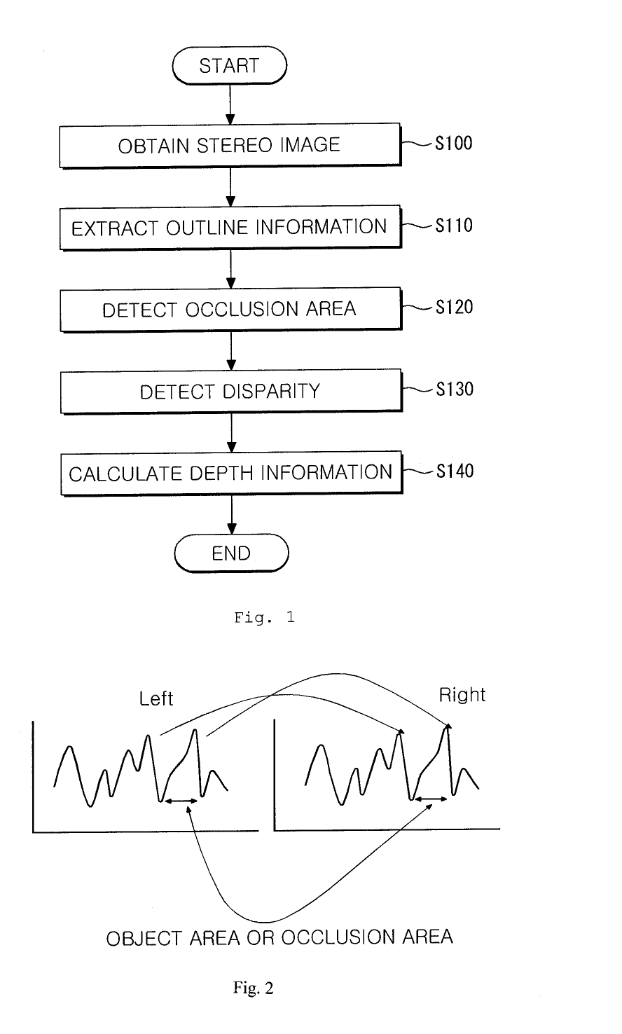

FIG. 2 is a luminance graph used in an outline extraction process of an object in accordance with the present invention.

Referring to FIG. 2, in a graph showing a luminance value of each of a current view and a reference view, a portion wherein the luminance value is sharply changed corresponds to an outline of each of the first object and the second object. An area between the outline corresponds to an inner area or the occlusion area of the object. That is, an area between a luminance edge of the luminance graph is the inner area or the occlusion area of the object.

By referring to the luminance graph shown in FIG. 2, the outline information of each of the first object and the second object may be obtained.

Thereafter, the occlusion area of the first object and the second object and an object area of each of the first object and the second object are detected from the extracted outline information (S120).

When the outline information is extracted, an area occupied by each of the first object and the second object in the image is established.

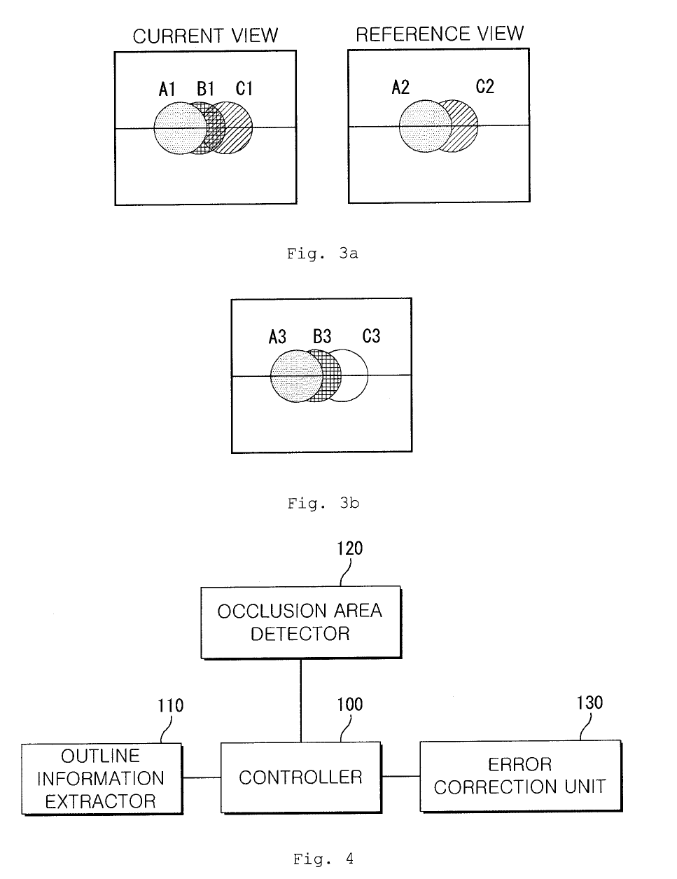

Since a disparity of a region A2 of FIG. 3a is obtained within a region A1, a search section obtained from the outline information obtained from FIG. 2 is used to search in the object area.

FIGS. 3a and 3b are diagrams illustrating a method for detecting the occlusion area of a method for detecting the depth information of the object in accordance with the present invention.

Referring to FIG. 3a, the areas occupied by each of the first object and the second object in a right image (current view) and a left image (reference image) photographed by the stereo image input means are different despite the same objects are photographed.

That is, the first object and the second object occupy the region A1 and a region C1 in the reference view while the first object and the second object occupy the region A2 and a region C2 in the current view. Therefore, the occlusion areas of the reference view and the current view are differently displayed in the image.

A region B1 represents the occlusion area in the current view. When a depth information of the region B1 is detected, an error having a large value is obtained in a search equation. That is, when a cost function has a value larger than a threshold value, it is determined that the error occurred. In addition, since feature points obtained in the region B1 does not have matching points in the current view, the region B1 is defined as the occlusion area.

Therefore, the occlusion area may be detected.

Referring to FIG. 3b, object areas A3 and C3 and an occlusion area B3 are determined from the reference view and the current view.

Each of the object areas A3 and C3 has a constant depth information with respect to the outline information, and the region B3 does not have the constant depth information.

Thereafter, the disparity of each of the first object and the second object is detected (S130). That is, the disparity is calculated from a change or a movement of the area occupied by the first object and the second object.

Thereafter, the depth information of each of the first object, the second object and the occlusion area is calculated.

Since each of the object areas A3 and C3 has the constant depth information with respect to the outline information and the region B3 does not have the constant depth information, an error is generated when the depth information of the region B3 is calculated. The error is corrected using a relation between the region A1 and the region C1. That is, since the region C1 includes the region B1, the depth information of the region C1 corresponds to that of the region B1. Therefore, an accurate depth information may be obtained when the depth information of the object area including the occlusion area is regarded as the depth information of the occlusion area.

FIG. 4 is a block diagram illustrating a depth information detection system in accordance with the present invention.

Referring to FIG. 4, the depth information detection system in accordance with the present invention comprises an outline information extractor 110, an occlusion area detector 120, a controller 100 and an error correction unit 130.

The outline information extractor 110 extracts an outline information of each of a first object and a second object included in an image obtained from a stereo image input means (not shown).

The outline information of each of the first object and the second object may be obtained from the luminance graph shown in FIG. 2. A portion wherein a luminance value is sharply changed corresponds to an outline of each of the first object and the second object. An area between the outline corresponds to an inner area or the occlusion area of the object. That is, an area between a luminance edge of the luminance graph is the inner area or the occlusion area of the object.

The occlusion area detector 120 detects an occlusion area of the first object and the second object from the outline information.

As described above with reference to FIGS. 3a and 3b, an error is generated when a depth information of the occlusion area is calculated. Therefore, the occlusion may be detected.

The controller 100 detects the depth information of each of the first object, the second object and the occlusion area.

The controller 100 calculates a disparity of each of the first object and the second object obtained from the outline information extracted by the outline information extractor 110, and calculates the depth information from the calculated disparity.

Since the error occurs during the calculation of the depth information in case of the occlusion area, the error is corrected by the error correction unit 130.

The error correction unit 130 corrects the error of the depth information of the occlusion area by assigning the depth information of the second object as that of the occlusion area.

As described above, the method and the system for calculating the depth information of the objects in the image in accordance with pi are advantageous in that the accurate depth information of each of the objects is obtained by classifying the area occupied by the two or more objects in the image into the object area and the occlusion area using the outline information.

1. A method for detecting a depth information of each of a first object and a second object included in an image obtained from a stereo image input means, the method comprising steps of:
(a) extracting an outline information of each of the first object and the second object;
(b) detecting an occlusion area of the first object and the second object from the outline information;
(c) detecting a disparity of each of the first object and the second object; and
(d) detecting the depth information of each of the first object, the second object and the occlusion area from the disparity.

2. The method in accordance with claim 1, wherein the step (a) comprises extracting the outline information from a luminance graph of the image.

3. The method in accordance with claim 1, wherein the step (b) comprises detecting an area between luminance edges of a luminance graph of the image as the occlusion area.

4. The method in accordance with claim 1, wherein the step (d) comprises correcting an error generated when detecting the depth information of the occlusion area.

5. The method in accordance with claim 4, wherein correcting the error comprises assigning the depth information of the second object as that of the occlusion area.

6. A depth information detection system comprising:
an outline information extractor for extracting an outline information of each of a first object and a second object included in an image obtained from a stereo image input means;
an occlusion area detector for detecting an occlusion area of the first object and the second object from the outline information;
a controller for detecting a depth information of each of the first object, the second object and the occlusion area from a disparity of each of the first object and the second object detected from the image; and
an error correction unit for detecting and correcting an error of the depth information of the occlusion area.

7. The system in accordance with claim 6, wherein the error correction unit assigns the depth information of the second object as that of the occlusion area.
